(19) United States
(12) Patent Application Publication
(10) Pub. No.: US 2017/0109796 A1
(43) Pub. Date: Apr. 20, 2017

(54) PRESENTING CONTENT SELECTED BY AN ONLINE SYSTEM VIA CONTENT PRESENTED BY AN APPLICATION ALONG WITH ADDITIONAL CONTENT PRESENTED BY THE APPLICATION

(71) Applicant: Facebook, Inc., Menlo Park, CA (US)

(72) Inventors: Bruno Rahle, London (GB); Andrey Mityagin, London (GB); Maksym Halushka, London (GB); Thomas Kadauke, London (GB)

(21) Appl. No.: 14/883,579

(22) Filed: Oct. 14, 2015

(51) Int. Cl. G06Q 30/02

(52) U.S. Cl. CPC G06Q 30/0272; G06Q 30/0277

(57) ABSTRACT

An online system provides instructions for inclusion in an application to an entity associated with the application. When the application executes the instructions, the application identifies content within the application capable of presenting content from the online system and requests a content item from the online system. Information identifying the user and a context in which the content item is to be presented may be provided to the online system. The application presents the content item from the online system via the identified content when the identified content is presented to the user by the application. Information describing a duration that the content item from the online system is presented by the application is communicated to the online system by the application, allowing the online system to more accurately maintain information describing presentation of the content item.

### BACKGROUND

This disclosure relates generally to online systems, and more specifically to capturing presenting content from an online system via content presented by an application executing on a client device along with content from the application.

An online system, such as a social networking system, allows users to connect to and to communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

The increasing popularity of online systems, such as social networking system, allows entities (e.g., businesses) to gain public attention for products or services or to persuade online system users to take actions regarding products or services provided by the entities via an online system. For example, an entity (e.g., a business) presents content items to online system users to gain public attention for products or services or to persuade online system users to take an action regarding products or services provided by the entity. Many online systems may receive compensation from an entity for presenting certain types of content items provided by the entity to online system users.

Additionally, users of an online system are often presented with content from various applications executing on client devices. For example, an application executing on a client device retrieves content from a source and presents content from the source to the user via the client device. However, many conventional client devices present content from a single application at a time, causing users to navigate between different applications to view content from different sources. For example, an application presents content based on a third party system, but does not present content from an online system other than the third party system. This causes a user to navigate between different applications executing on a client device to access content from different sources, increasing the complexity of the user accessing content from the online system, which may reduce the likelihood of the user being presented with content from the online system.

### SUMMARY

A user of an online system receives content via one or more applications executing on a client device associated with the user. An application may receive content from a third party system or from the online system and present the content to the user via the client device. The online system provides instructions to entities providing applications that present content to users when executed on a client device. In various embodiments, the online system provides an entity providing an application with a software development kit (SDK) including the instructions, and instructions from the SDK are included in the application. Hence, when the application is executed on a client device, instructions from the SDK are executed by the client device. The instructions identify content within the application capable of presenting a content item from the online system, such as an advertisement, to a user. For example, if the application is a game, while the game is executed on the client device, executing the instructions identifies one or more objects presented by the game capable of presenting a content item from the online system. The instructions may identify different types of objects presented by the applications, such as objects having particular characteristics (e.g., size, shape, color, location relative to other objects). For example, if the application presents various objects, executing the instructions in the application identifies objects presented in a background of the application or objects having certain dimensions when presented. In a specific example, executing the instructions identifies objects presented in a background of the application that have at least one flat or rectangular surface when presented by the application.

If execution of the instructions identifies content presented by the application capable of presenting a content item from the online system, the application a request for content to the online system. The request includes information identifying the user of the client device to the online system. For example, the application retrieves information stored by the application or by an entity associated with the application (e.g., a third party system) and includes the retrieved information (e.g., demographic information, prior interactions with the application 115, interests of the user, etc.) in the request. Additionally, the request may include information describing a context of the application in which content from the online system is to be presented. The context of the application may be based on prior interactions by the user with the application, content previously presented to the user by the application, data associated with the user by the application, or other suitable information describing the user's state in the application. For example, the request includes one or more topics. Various topics may be associated with different topics with different contexts in which application content is to be presented. The context of the application in which the content from the online system is to be presented may be based on how the content from the online system is to be presented via the application. For example, the request includes information describing one or more display characteristics of the application (e.g., a resolution with which the client device displays content from the application, an aspect ratio of the content presented by the application that is capable of presenting an advertisement, a color of the content presented by the application capable of presenting an advertisement, additional content presented by the application.

When the application receives a content item selected by the online system, executing the instructions provided by the online system causes the application to determine when the identified content presented by the application capable of presenting the content from the online system is presented to the user. In various embodiments, executing the instructions from the online system determines when at least a threshold amount of the identified content capable of presenting the content item is within a field of view of the user within the application. The field of view of the user within the application is the content presented to the user by the application via the client device at a current time. For example, executing the instructions from the online system determines when at least 50% of the identified content is presented to the user by the application. The threshold amount of the identified content capable of presenting the content from the online system may be a percentage of the identified content or may be a specified amount. Different types of identified content may be associated with different threshold amounts that, when presented to the user, cause determination that the identified content is presented to the user. For example, if the application is a game, an object presented nearer to the user by the game is determined to be presented to the user when a smaller amount of the object is presented by the game, while a larger amount of an object presented farther from the user by the game is presented before determination that the object is presented to the user.

In response to determining the identified content capable of presenting the advertisement is presented to the user by the application, the application presents the content item received from the online system via the identified content. For example, the application 115 overlays the received content item on the identified content, so the received advertisement is presented via the application as a surface of the identified content that is presented along with other content by the application. If the application is a game, the received content item is presented as an overlay on a surface of an object within the user's field of view in various embodiments. As an example, the received content item is presented on a surface of a wall or of a virtual billboard presented to the user by the game. Presenting the received advertisement via the identified content allows presentation of the content item from the online system while the user interacts without the application without distracting from interaction with the advertisement and also allows the received content item to be more organically presented while the user interacts with the application.

The application transmits information describing presentation of the received content item to the online system. In some embodiments, the application transmits the information while the application presents the received content item. For example, the application transmits information describing presentation of the received content item at periodic intervals while the content item is presented by the application. The transmitted information includes an identifier of the content item and information describing a duration that the received content item has been presented by the application. For example, the transmitted information includes the identifier of the received content item, a time when the application started presenting the content item, and a current time. By applying one or more stored rules to the information from the application, the online system determines whether the received content item was presented to the user by the application. Various rules identify a minimum length of time the received content item was presented as well as a minimum amount of the received content item presented for the online system to determine the received content item was presented (i.e., to determine an impression of the received content item occurred). Different rules may be maintained by the online system for different content items or for different types of content items. For example, a set of rules is associated with content items that are advertisements, while another set of rules is associated with content items other than advertisements. A rule may identify a combination of duration of length of time a content item was presented by the application and a minimum amount of the content item presented by the application to identify an impression of the content item. If information describing presentation of the received content item satisfies one or more rules associated with the received content item by the online system, the online system stores information identifying an impression in association with the received content item.

Executing the instructions from the online system also causes the application to determine whether the identified content continues to be presented to the user. In various embodiments, the application determines whether at least a threshold amount of the identified content is visible within a field of view of the user within the application. If less than the threshold amount of the identified content is visible within user's field of view within the application, the application determines the identified content is not presented to the user and ceases presentation of the selected advertisement via the identified content. For example, if less than 30% of the identified content is visible within the user's field of view within the application, the application determines is not presented to the user, and the application ceases presentation of the received content item. In some embodiments, the application ceases presenting the received content item by removing an overlay presenting the selected content item from the identified content. If the received content item includes video data, the application may cease presentation of the received content item by presenting a frame of the video data as an overlay on the identified content rather than presenting the video data. If the received content item includes audio data, the application reduces the volume of the audio data or stops playing the audio data to cease presentation of the selected audio data.

The application transmits information describing cessation of presentation of the received content item to the online system. For example, the application transmits a time when presentation of the received content item is ceased along with the identifier of the received content item. In some embodiments, the online system determines whether the received content item was presented to the user by the application (i.e., whether an impression of the received content item occurred) based on a time when the application started presenting the received content item from the transmitted information and a time when the application ceased presenting the selected advertisement. For example, the online system determines a difference between the time when the application began presenting the received content item and the time when the application ceased presenting the received content item. If the determined difference equals or exceeds a threshold length of time, the online system stores information in association with the identifier of the received content item indicating the received content item was presented to a user.

Presenting a content item selected by the online system via content presented by the application increases the opportunities for the online system to provide content to the user. Presenting the content item selected by the online system using the application's content allows the online system's content item to be presented without distracting or impairing the user's interaction with the application. As the request from the application to the online system for the content item may include information describing a context within the application in which the content item is to be presented, the content item selected by the online system is more likely to be relevant to the user's interaction with the application, which may increase the likelihood of the user interacting with the content item by dynamically selecting the content item for presentation via the application.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for presenting content from an online system within an application executing on a client device, in accordance with an embodiment.

FIG. 4 is an example of content from an online system presented within content provided by an application executing on a client device, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

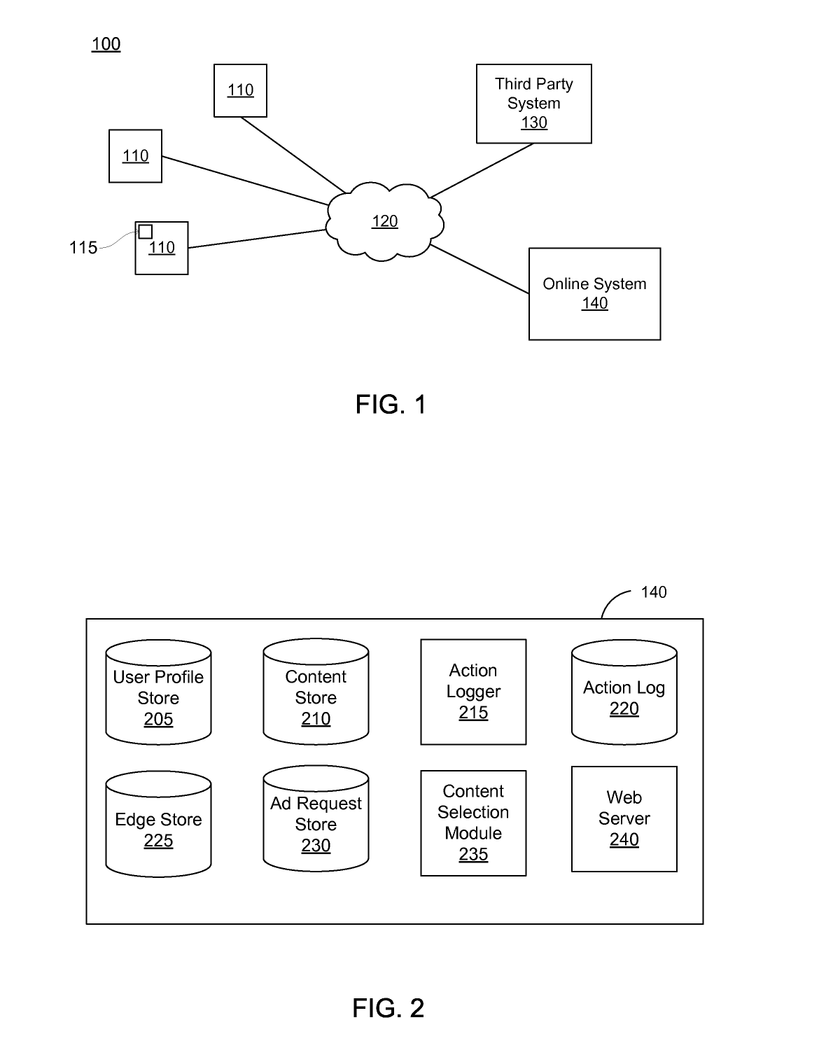

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

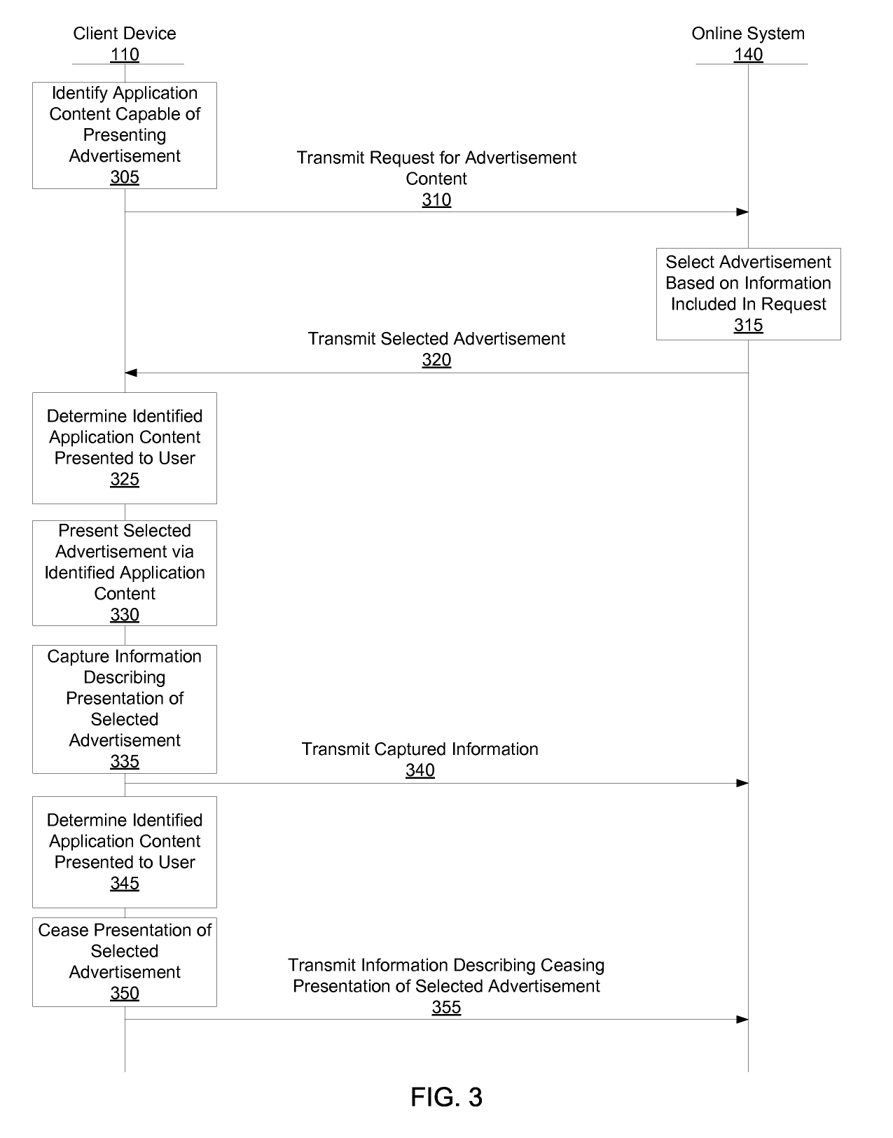

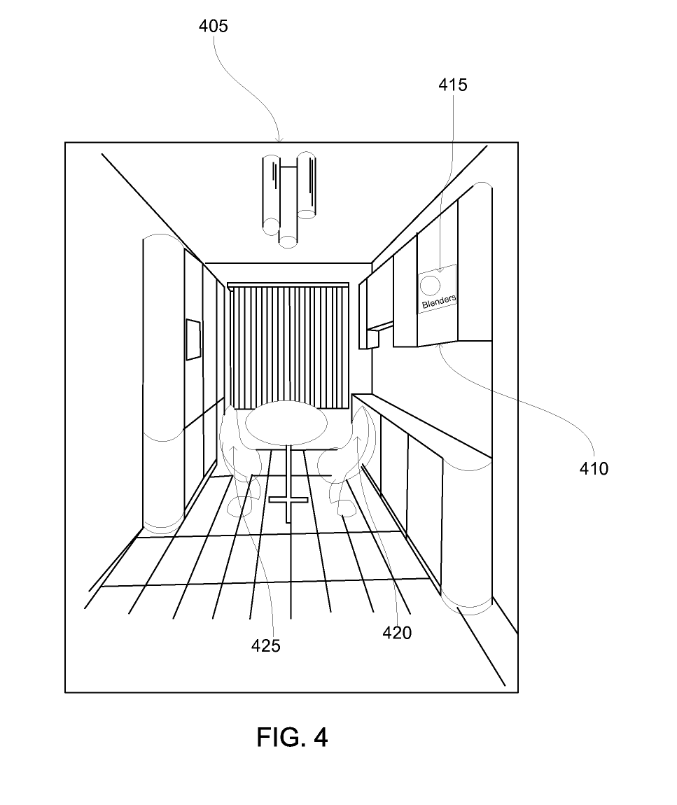

A client device 110 may execute one or more applications 115 that provide content to a user via the client device 110 or receive interactions from a user via the client device 110. In some embodiments, an application 115 presents content to the user based in part on interactions from a user received by the application 115. The application 115 may obtain content for presentation from one or more third party systems 130 or from the online system 140. In various embodiments, the application 115 includes instructions from the online system 140 that, when executed by the application 115, identify content within the application 115 capable of presenting content from the online system 140, obtain content from the online system 140, and present the obtained content to the user via the identified content within the application 115. For example, the application 115 includes instructions from a software development kit (SDK) provided to an entity associated with the application 115 by the online system 140. As further described below in conjunction with FIG. 3, when the instructions from the SDK are executed by a client device 110 that executes the application 115, the application 115 identifies content within the application 115 capable of presenting content from the online system 140 (e.g., an advertisement) to a user and communicates a request for content to the online system 140. When the application 115 receives content from the online system 140, the application 115, by executing the instructions from the online system 140, determines when content provided by the application 115 capable of presenting the received content is visible to or otherwise noticeable by the user and presents the content received from the online system 140 via the content provided by the application 115. Hence, presenting content from the online system 140 using content provided by the application 115 allows the online system 140 to provide more content to users without distracting from the user's interaction with the application 115. As further described below in conjunction with FIG. 3, executing the instructions also causes the application 115 to capture information describing presentation of content from the online system 140 by the application 115 and to communicate the captured information to the online system 140, allowing the online system 140 to account for presentation of content via the application 115 when maintaining information describing presentation of content.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, an advertisement request (“ad request”) store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. As an example, content provided by a third party system 130 to users of the online system may be identified along with information identifying an online system user 140 by information received by the online system 140, and the action logger 215 stores information identifying the content provided by the third party system 130 in the action log 220 in association with the identified user of the online system 140. As another example, the action logger 215 logs information describing interactions between a user of the online system 140 and an application 115 based on information communicated to the online system 140 by instructions executed by the application 115. For example, the application 115 communicates information to the action logger 215 identifying a length of time that the application 115 presents content from the online system 140 or identifying a time when the application 115 began presenting content from the online system 140 and a time when the application ceased presenting content from the online system 140. The action logger 215 maintains one or more rules associating actions with information from the application 115 describing presentation of content from the online system 140 by the application 115. Various rules identify a minimum length of time the application 115 presents a content item from the online system 140 causing the action logger 215 to store information in the action log 220 indicating the content item was presented to a user (i.e., to identify an impression of the content item to a user). In some embodiments, a rule also specifies a minimum amount of the content item from the online system 140 presented by the application 115 to cause the action logger 215 to determine the content item was presented to a user. For example, a rule is associated with an identifier of a content item causing the action logger 215 to identify an impression of the content item to a user if a minimum amount of the content item was presented by the application 115 for at least a threshold length of time; hence, the action logger 215 updates the action log 220 to identify an impression of the content item corresponding to the identifier if information received along with the identifier specifies the application presented at least the minimum amount of the content item for at least the threshold length of time. Different rules may be associated with different content items or with content items having different characteristics. Various rules may specify different combinations of minimum amounts of content items presented and different lengths of time for which at least the minimum amounts of content items were presented by the application 115. Accordingly, the action logger 215 logs information identifying presentation of a content item, such as an advertisement, if information identifying the content item also includes information satisfying one or more rules associated with the content item.

Additionally, the action logger 215 logs information interactions between online system users and advertisements presented to the online system users. For example, information describing a number of times a user of the online system 140 clicked on an advertisement or completed a purchase through interacting with an advertisement is logged by the action logger 215 in association with information identifying the user; times associated with the interactions may also be stored in association with information identifying the user and identifying the advertisement. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items (including advertisements), and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. The online system 140 stores the information describing the user's interactions with the content provided by the third party system 130 in association with the user in the action log 220. Hence, the action log 220 may record information about actions users perform on a third party system 130, including webpage viewing histories, interactions with advertisements, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items eligible for presentation to the user may include advertisements from ad requests or other content items associated with bid amounts. The content selection module 235 uses the bid amounts associated with ad requests when selecting content for presentation to the user. In various embodiments, the content selection module 235 determines an expected value associated with various ad requests (or other content items) based on their bid amounts and selects content items associated with a maximum expected value or associated with at least a threshold expected value for presentation. An expected value associated with an ad request or with a content item represents an expected amount of compensation to the online system 140 for presenting an ad request or a content item. For example, the expected value associated with an ad request is a product of the ad request's bid amount and a likelihood of the user interacting with the ad content from the ad request. The content selection module 235 may rank ad requests based on their associated bid amounts and select ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user. For example, information describing actions associated with other users connected to the user or other data associated with users connected to the user are retrieved. Additionally, one or more advertisement requests (“ad requests”) may be retrieved from the ad request store 230 The retrieved stories, ad requests, or other content items, are analyzed by the content selection module 235 to identify candidate content items, including ad requests, eligible for presentation to the user. For example, content items associated with users who not connected to the user or stories associated with users for whom the user has less than a threshold affinity are discarded as candidate content items. Based on various criteria, the content selection module 235 selects one or more of the content items or ad requests identified as candidate content for presentation to the identified user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a newsfeed including a plurality of content items selected for presentation to the user. One or more advertisements may also be included in the feed. The content selection module 235 may also determine the order in which selected content items or advertisements are presented via the feed. For example, the content selection module 235 orders content items or advertisements in the feed based on likelihoods of the user interacting with various content items or advertisements.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, analyzed information, instant messages, queued messages (e.g., email), text messages, short message service (SMS) messages, or messages sent using any other suitable messaging technique. A user may send a request to the web server 240 to upload information (e.g., images or videos) that is stored in the content store 210. Additionally, the web server 240 may provide application programming interface (API) functionality to send data directly to native client device operating systems, such as IOS®, ANDROID™, WEBOS®, or BlackberryOS.

Presenting Advertisements from an Online System to a User Via an Application

FIG. 3 is an interaction diagram of one embodiment of a method for presenting advertisements selected by an online system 140 via an application 115 executing on a client device 110. In other embodiments, the method may include different and/or additional steps than those shown in FIG. 3. Additionally, steps of the method may be performed in different orders than the order described in conjunction with FIG. 3 in various embodiments.

The online system 140 provides instructions to entities providing applications that are executed on client devices 110 to present content. In various embodiments, the online system 140 provides an entity providing an application 115 with a software development kit (SDK) including the instructions, allowing the entity to include the instructions in the application via the SDK. An entity includes the instructions in an application 115 and when the instructions are executed by a client device 110 executing the application 115, the application 115 identifies content within the application 115 capable of presenting an advertisement to a user and communicates a request for advertisement content to an online system 140. When the application 115 receives an advertisement from the online system 140, executing the instructions causes the application 115 to determine when the content within the application 115 capable of presenting the advertisement is presented to the user and to present the advertisement received from the online system 140 via the content within the application 115. As further described below in conjunction with FIG. 3, executing the instructions also causes the application 115 to capture information describing presentation of the advertisement from the online system 140 by the application 115 and to communicate the captured information to the online system 140, allowing the online system 140 to account for presentation of content via the application 115 when maintaining information describing presentation of advertisements selected or provided by the online system 140.

The application 115 including the instructions from the online system 140 executes on a client device 110 and presents content to a user of the client device 110 using the client device 110. For example, the user retrieves the application 115 from the online system 140 or from a third party system 130 and installs the application 115 on the client device 110. In various embodiments, the application 115 presents image data, video data, audio data, or a combination of data to the user via the client device 110. Additionally, the application 115 receives input from the user via the client device 110 and may modify the content presented by the application 115 based on the received input. For example, the application 115 is a game that presents image data, video data, or audio data to the user via the client device 110.

As the application 115 executes on the client device 110, and presents content to the user, the client device 110 executes the instructions from the online system 140 included in the application 115 that identify 305 content presented via the application 115 that is capable of presenting an advertisement to the user. In various embodiments, the instructions in the application 115 include one or more criteria for presenting an advertisement, so the client device 110 identifies 305 content presented by the application 115 that satisfies at least a threshold number or a threshold percentage of the criteria. For example, if the application 115 presents various objects, executing the instructions in the application 115 identifies 305 objects having certain characteristics. As an example, execution of the instructions identifies 305 objects having certain display characteristics (e.g., objects presented in a background of the application, objects having certain dimensions when presented). In a specific example, executing the instructions identifies 305 objects presented in a background of the application that have at least one flat surface when presented.

If the application 115 executing the instructions identifies 305 content presented by the application 115 capable of presenting an advertisement, the application 115 transmits 310 a request for advertisement content to the online system 140 via the client device 110 and a network 120 coupled to the client device 110 and to the online system 140. The request includes information identifying the user of the client device 110 to the online system 140. For example, the application 115 retrieved information maintained by a third party system 130 describing the user (e.g., demographic information, prior interactions with the application 115, interests of the user, etc.) and includes the retrieved information in the request transmitted 310 to the online system 140. In various embodiments, certain types of information describing the user maintained by the third party system 130 is prevented from being included in the request (e.g., information uniquely identifying the user to the third party system 130), while other types of information are capable of being included in the request transmitted 310 to the online system 140.

As another example, the online system 140 and an entity associated with the application 115 (e.g., a third party system 130) synchronize, or match, identifiers stored on the client device 110 and associated with the user by the entity and with the user by the online system 140. For example, the online system stores an identifier associated with the user, such as a cookie, on the client device 110. Similarly, the entity associated with the application 115 stores an identifier associated with the user by the entity on the client device 110. Instructions included in the application 115 communicate a request to the entity including the identifier associated with the user and stored on the client device 110 by the entity. In response to receiving the request, the entity communicates a redirect request to the client device 110 for the client device 110 to communicate a request to the online system 140. The redirect request includes the identifier associated with the user by the entity (e.g., the cookie stored on the client device 110 by the entity 130). When the client device 110 communicates the request to the online system 140 specified by the redirect request, the request communicated from the client device 110 to the online system 140 includes the identifier associated with the user and stored on the client device 110 by the online system 140 (e.g., the cookie stored on the client device 110 by the online system 140). Additionally, the request communicated from the client device 110 to the online system 140 includes the identifier associated with the user by the entity obtained from the redirect request from the entity. Hence, the online system 140 may extract the identifier associated with the user by the entity from the request communicated to the online system 140 from the client device 110 and associate the identifier associated with the user by the entity with the identifier associated with the user by the online system 140. The online system 140 identifies the user from the identifier associated with the user by the online system 140 included in the request and links the identifier associated with the user by the entity with the user. For example, the redirect request from the entity to the client device 110 includes a cookie associated with the user by the entity, which is included in the request from the client device 110 to the online system 140 that also includes a cookie associated with the user by the online system 140. The online system 140 identifies the user based on the cookie associated with the user by the online system 140 and stores information associating the cookie associated with the user by the entity with the cookie associated with the user by the online system 140.

Additionally, the request includes information describing a context of the application 115 in which the advertisement content is to be presented. The context of the application 115 may be based at least in part on prior interactions by the user with the application 115, content previously presented to the user by the application 115, data associated with the user by the application 115, or other suitable information describing the user's state in the application 115 or content presented by the application 115. For example, the request includes one or more topics. In various embodiments, an entity associated with the application 115 associates various topics with different contexts in which application content is to be presented. Different topics may be associated with different combinations of prior interactions with the application 115 by the user, with different additional content presented to the user along with the content capable of presenting an advertisement, with different content previously presented to the user, or with any combination of the preceding factors. One or more of the topics included in the request are based on the context in which the content capable of presenting an advertisement is to be presented by the application 115, while other topics included in the request are based on other information (e.g., topics associated with the application or with the user) in some embodiments.

The context of the application in which the advertisement is to be presented may be based on how the advertisement is to be presented to the user by the application 115. For example, the request includes information describing one or more display characteristics of the application 115. Example display characteristics include a resolution with which the client device 110 displays content from the application 115, an aspect ratio of the content presented by the application 115 that is capable of presenting an advertisement, a color of the content presented by the application 115 capable of presenting an advertisement, additional content presented by the application 115 in conjunction with the content capable of presenting an advertisement (e.g., additional objects presented along with an object capable of presenting the advertisement), or other suitable information describing presentation of the content capable of presenting the advertisement by the application 115. In various embodiments, the application 115 provides audio data, with portions of the audio data capable of presenting an advertisement. Hence, the request may identify a volume of the audio data provided by the application 115, a source of the audio data relative to the user's location within the application 115 (e.g., whether audio data is presented from a source behind the user's location relative to content presented by the application 115, whether audio data is presented from a source in front of the user's location relative to content presented by the application 115, etc.), whether the audio data capable of presenting the advertisement is foreground audio data or background audio data, other audio data presented by the application 115, or other suitable information.

Based on the request received form the application 115 via the client device 110, the online system 140 selects 315 an advertisement for presentation to the user via the application 115. As further described above in conjunction with FIG. 2, the online system 140 identifies stored advertisement requests (“ad requests”) having at least a threshold number of targeting criteria satisfied by information included in the request and selects 315 an advertisement from the identified stored ad requests. For example, the online system 140 ranks identified ad requests based at least in part on their bid amounts and selects 315 an advertisement from an ad request having at least a threshold position in the ranking (e.g., an ad request having a highest position in the ranking) As another example, the online system 140 selects 315 an advertisement from an ad request having a maximum bid amount. In some embodiments, the online system 140 identifies information associated with the user by the online system 140 based on information identifying the user to the online system 140 included in the request and accounts for the information associated with the user by the online system 140. For example, the online system 140 determines a likelihood of the user interacting with advertisements from various ad requests based on prior interactions with content items stored in association with the user by the online system 140, and selects an advertisement based on expected values that are based on bid amounts associated with ad requests including advertisements and likelihoods of the user interacting with advertisements in ad requests, as further described above in conjunction with FIG. 2. In some embodiments, the online system 140 selects 315 multiple advertisements, such as advertisements from ad requests having at least a threshold position in a ranking or advertisements having at least a threshold expected value.

The online system 140 transmits 320 the selected advertisement (or advertisements) to the client device 110, which receives the selected advertisement and communicates it to the application 115. In various embodiments, the application 115 stores the received advertisement or advertisements. For example, the application 115 stores the received advertisement for a threshold amount of time.

After receiving the advertisement (or advertisements) selected by the online system 140, the application 115 determines 325 the identified content capable of presenting the advertisement is presented to the user by the application 115. In various embodiments, the application 115 determines 325 the identified content capable of presenting the advertisement is presented to the user when at least a threshold amount of the identified content is presented to the user by the application 115. For example, if at least 40% of the identified content is presented to the user, the application 115 determines 325 the identified content is presented to the user. In some embodiments, the application 115 determines 325 the identified content is presented to the user if at least a threshold percentage of the identified content is within a field of view of the user when interacting with the application 115. The field of view of the user within the application 115 is the content presented to the user by the application 115 via the client device 110 at a current time. For example, the field of view of the user within the application 115 is a portion of the content provided by the application 115 presented via a display device of the client device 110 executing the application 115. For example, if the application 115 is a game, the field of view of the user is content from the game presented to the user via a display device of the client device 110 at a current time. In some embodiments, the application 115 determines 325 the identified content is within the field of view of the user if at least a threshold amount of the identified content is within the field of view of the user. The threshold amount may be a percentage of the identified content or may be a specified amount. Different types of identified content may be associated with different threshold amounts that, when presented to the user, cause the application 115 to determine 325 the identified content is presented to the user. For example, if the application 115 is a game, an object presented nearer to the user by the game is determined 325 as presented to the user when a smaller amount of the object is presented by the game, while a larger amount of an object presented farther from the user by the game is presented before the application 115 determines 325 the object is presented to the user (e.g., a smaller amount of an object in the foreground of the game is presented for the application 115 to determine 325 the object is presented to the user than for the application 115 to determine 325 an object in the background of the game is presented). As another example, the application 115 determines audio data from one or more specific sources or specific types of sources is presented by the application 115 to determine 325 the identified content is presented to the user by the application 115.

In response to determining 325 the identified content capable of presenting the advertisement is presented to the user by the application 115, the application 115 presents 330 the selected advertisement received from the online system 140 via the identified content. For example, the application 115 overlays the received advertisement on the identified content, so the received advertisement is presented via the application 115 along with other content presented by the application 115. If the application 115 is a game, the selected advertisement is presented 330 as an overlay on a surface of an object within the user's field of view in various embodiments; as an example, the selected advertisement is presented 330 on a surface of a wall or of a virtual billboard presented to the user by the game. Presenting the selected advertisement via the identified content allows the selected advertisement to be presented 330 while the user interacts without the application 115 without distracting from interaction with the advertisement and allows the advertisement to be more organically presented 330 while the user interacts with the application 115.

In response to presenting 330 the selected advertisement via the identified content capable of displaying an advertisement, the application 115 captures 335 information describing a duration the selected advertisement is presented 330 via the identified content of the application 115. The captured information describing the duration may identify a time when the selected advertisement was initially presented 330 via the identified content. In various embodiments, the captured information describes a duration during which at least a threshold amount of the selected advertisement is within a field of view of the user within the application 115. For example, the duration identifies a length of time that at least a threshold amount of the selected advertisement is visible to the user within the field of view of the user within the application; as an example, information describing the duration specifies a length of time that at least 60% of the selected advertisement is visible in the user's field of view within the application 115. If the selected advertisement includes audio data, the duration specifies a length of time the advertisement is audible to the user via the application 115. For example, the duration of presentation of audio data in an advertisement specifies a length of time the application plays the audio data in the advertisement with at least a threshold volume.

The application 115 transmits 340 the captured information from the client device 110 to the online system 140 along with an identifier of the selected advertisement that was presented 330. In some embodiments, the application 115 transmits 340 captured information at periodic intervals to provide the online system 140 with information describing presentation 330 of the selected advertisement over time. Alternatively, the online system 140 communicates a request to the application 115 for the captured information, and the application 115 transmits 340 the captured information to the online system 140 in response to receiving the request. In other embodiments, the application 115 transmits 340 the captured information when certain criteria are satisfied. For example, the application 115 transmits 340 the captured information when the selected advertisement has been presented 330 for a threshold length of time or when the amount of the selected advertisement visible (or audible) to the user via the application 115 increases or decreases by a specified percentage or amount. The online system 140 stores the captured information along with the identifier of the selected advertisement and applies one or more rules to the description of the duration the selected advertisement was presented 330. Various rules identify a minimum length of time the selected advertisement was presented 330 corresponding to an impression of the selected advertisement to the user, a minimum amount of the selected advertisement to be presented 330 to the user corresponding to an impression of the selected advertisement, or a minimum length of audio data in the selected advertisement presented 330 to the user corresponding to an impression of the selected advertisement. A rule may identify a combination of duration of length of time the selected advertisement was presented 330 by the application 115 and a minimum amount of the selected advertisement presented 330 by the application 115 to identify an impression of the selected advertisement. If the captured information satisfies one or more rules identifying an impression of the selected advertisement, the online system 140 stores information identifying an impression in association with the identifier of the selected advertisement or modifies stored information associated with the identifier of the selected advertisement to indicate an impression of the selected advertisement occurred.

Additionally, the user may interact with the selected advertisement via the application 115 while the selected advertisement is presented 330 to the user via the application 115. Various interactions with the application 115 may be identified by the application 115, which modifies presentation of the selected advertisement based on an identified interaction. Modifications to advertisement presentation corresponding to interactions with the application 115 may be specified by an entity associated with the selected advertisement and communicated to the client device 110 on which the application 115 executes along with the selected advertisement or may be determined by the application 115. For example, certain interactions cause the application to cease presentation of the selected advertisement or to modify how the selected advertisement is presented. As an example, if the application 115 is a game and the selected advertisement includes video or audio data, interacting with one or more objects in the game (e.g., a remote control included in a virtual environment, an object on which the selected advertisement is presented 330) increase or decrease the volume of audio data presented by the selected advertisement. In other embodiments, interactions with the application 115 (e.g., with objects within the application 115 or with content provided by the application 115) pause video data comprising the selected advertisement, change a playback speed of video data comprising the selected advertisement, cease presentation 330 of the selected advertisement, or perform any other suitable modification to presentation of the selected advertisement. As a specific example, if the application 115 is a game allowing the user to shoot virtual objects within the application 115, if the user shoots the identified content within the application 115 presenting the selected advertisement, presentation 330 of the advertisement is ceased or if the user shoots a particular object presented by the application 115, presentation 330 of the advertisement is paused and may be resumed if the user shoots the particular object or another object presented by the application 115. Hence, interacting with the application 115 allows the user to modify presentation 330 of the selected advertisement via the application 115. The application 115 transmits information to the online system 140 identifying the selected advertisement and a modification of presentation 330 of the selected advertisement corresponding to a received interaction with the application 115, allowing the online system 140 to store information describing presentation 330 of the selected advertisement to the user.

While the selected advertisement is presented 330 by the application 115 via the identified content within the application 115, the application 115 determines 345 whether the identified content continues to be presented to the user. In various embodiments, the application 115 determines whether at least a threshold amount of the identified content is visible within a field of view of the user within the application. If less than the threshold amount of the identified content is visible within user's field of view within the application, the application 115 determines 345 the identified content is not presented to the user and ceases 350 presentation of the selected advertisement via the identified content. For example, if less than 30% of the identified content is visible within the user's field of view within the application 115, the application 115 determines 345 is not presented to the user and ceases 350 presentation of the selected advertisement. In some embodiments, when the application 115 ceases 350 presenting the selected advertisement, the application 115 removes an overlay presenting 330 the selected advertisement from the identified content, so the identified content itself is presented by the application 115. If the selected advertisement includes video data, the application 115 may stop playing the video data and present a frame from the video data via an overlay on the identified content to cease 350 presentation of the selected advertisement. If the selected advertisement includes or comprises audio data, the application 115 reduces the volume of the audio data or stops playing the audio data to cease 350 presentation of the selected advertisement.

In various embodiments, the application 115 transmits 355 information describing the ceasing 350 of presentation of the selected advertisement to the online system 140. For example, the application 115 transmits 335 a time when presentation of the selected advertisement is ceased 350 along with the identifier of the selected advertisement. In some embodiments, the online system 140 determines whether an impression of the selected advertisement occurred based on a time when the application 115 started presenting the selected advertisement and a time when the application 115 ceased 350 presenting the selected advertisement. For example, the online system 140 determines a difference between the time when the application 115 began presenting the selected advertisement and the time when the application 115 ceased 350 presenting the selected advertisement. The online system 140 compares the determined difference to a threshold length of time associated with an impression; if the determined difference equals or exceeds the threshold length of time, the online system 140 modifies information associated with the identifier of the selected advertisement to identify occurrence of an impression of the selected advertisement. Hence, the online system 140 may determine whether an impression of the selected advertisement occurred via the application 115 based on information from the application 115 describing presentation of the selected advertisement or based on information from the application 115 identifying starting and ending times of presentation of the selected advertisement by the application 115. Identifying impressions of the selected advertisement via the application 115 allows the online system 140 to maintain accurate information describing presentation of the selected advertisement that accounts for presentation of the selected advertisement via the application 115. Hence, the application 115 determines when to present 330 the selected advertisement via identified content presented via the application 115 and when to cease 350 presentation of the selected advertisement via the application 115, while instructions provided to the application 115 by the online system 140 automate the other functionality described above in conjunction with FIG. 3, simplifying presentation of an advertisement from the online system 140 via the application 115.

While FIG. 3 describes selection and presentation of an advertisement via identified content presented by the application 115, any content item may be selected by the online system 140 and subsequently presented 330 by the application 115 via identified content capable of presenting the content item. For example, the application 115 transmits 310 a request to the online system 140 for content identifying a type of content item (e.g., advertisement, informational, description of actions by other online system users, etc.) and including information allowing the online system 140 to identify information associated with the user by the online system 140. The online system 140 selects 315 a content item for the user based at least in part on the user's likelihood of interacting with the selected content item and transmits 320 the selected content item to the application 115, which displays the content item via identified content capable of presenting the application as described above.

FIG. 4 is an example presentation of content from an online system 140 within content provided by an application 115 executing on a client device 110. In the example of FIG. 4, the application 115 presents content 405 depicting a room to a user. For example, the application in FIG. 4 is a game and the room shown in FIG. 4 is part of a gaming environment presented by the application via a display device of a client device 110. The content 405 includes various objects 410, 420, 425 that are presented to the user. For purposes of illustration, FIG. 4 identifies three objects 410, 420, 425, but various numbers of objects may be identified from the content 405 presented by the application 115 in various embodiments.

In the example of FIG. 4, the application 115 identifies object 410 as capable of presenting content from the online system 140, while objects 420, 425 are not capable of presenting content form the online system 140. For example, object 410 includes a flat surface having at least threshold dimensions when displayed, while objects 420, 425 do not have a flat surface satisfying the threshold dimensions. In another example, objects 420, 425 are capable of being interacted with by the user via the application 115, while object 410 is an object with which the user is incapable of interacting. Hence, presenting content from the online system 140 would impair the user's interaction with the application 115, so objects 420, 425 are incapable of presenting content from the online system 140, while object 410 is capable of presenting content from the online system 140.

As described above in conjunction with FIG. 3, in response to identifying object 410 as capable of presenting content from the online system 140, the application requests a content item 415, such as an advertisement, from the online system 140. After receiving the content item 415 from the online system 140, when the application 115 determines object 410 is presented to the user, the application 115 presents the content item 415 via the object 410. For example, when at least a threshold percentage or amount of object 410 is visible to the user or when object 410 is within a threshold distance of a specified position in the user's field of view within the application 115, the application 115 determines object 410 is presented to the user. The application 415 presents the content item 415 from the online system 140 as an overlay on object 410 when object 410 is presented to the user. As shown in FIG. 4, this allows the user to interact with content 405 from the application 115 while also allowing the online system 140 to present the content item 415. Content 405 from the application 115 with which the user is capable of interacting is not obscured by the content item 415, so user interaction with the application 115 is not impaired. As described above in conjunction with FIG. 3, when requesting the content item 415 from the online system 140, the application 115 may provide the online system 140 with information describing a context in which the content item 415 is to be presented. This allows the content item 415 to include information relevant to other content 405 presented by the application, which may increase the likelihood of the user viewing or hearing the content item 415 while interacting with the application 115. For example, in FIG. 4, the content item 415 is an advertisement for an item likely to be included in the room depicted by the content 405. As described above in conjunction with FIG. 3, when object 410 is no longer presented to the user by the application 115 (e.g., when less than a threshold amount of object 410 is presented, when object 410 is greater than a threshold distance from a position within the user's field of view within the application 115), the application 115 may cease presentation of the content item 415 and present object 410 without an overlay including the content item 415.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
executing an application on a client device, the application presenting content to a user of the client device;
identifying content presented via the application capable of presenting an advertisement to the user;
transmitting a request for advertisement content to an online system, the request including information identifying the user to the online system;
receiving an advertisement selected for presentation to the user from the online system;
determining the identified content capable of presenting the advertisement to the user is presented to the user by the application;
presenting the received advertisement to the user via the identified content capable of presenting the advertisement;
in response to presenting the received advertisement, capturing information describing a duration the received advertisement is presented to the user via the identified content capable of presenting the advertisement; and
transmitting the captured information describing the duration to the online system.

2. The method of claim 1, wherein determining the identified content capable of presenting the advertisement to the user is presented to the user by the application comprises:
determining the identified content is within a field of view of the user within the application.

3. The method of claim 2, wherein determining the identified content is within the field of view of the user within the application comprises:
determining at least a threshold percentage of the identified content is within the field of view of the user within the application.

4. The method of claim 2, wherein determining the identified content is within the field of view of the user within the application comprises:
determining at least a threshold amount of the identified content is presented to the user via the application.

5. The method of claim 2, wherein capturing information describing the duration the received advertisement is presented to the user via the identified content capable of presenting the advertisement comprises:
capturing a length of time at least a threshold amount of the identified content is within the field of view of the user while the received advertisement is presented by the identified content.

6. The method of claim 1, further comprising:
ceasing presentation of the received advertisement in response to determining the identified content capable of presenting the advertisement to the user is no longer presented to the user by the application; and
transmitting information describing the ceasing presentation of the received advertisement to the online system.

7. The method of claim 6, wherein transmitting information describing the ceasing presentation of the received advertisement to the online system comprises:
transmitting a time when presentation of the received application was ceased to the online system.

8. The method of claim 1, wherein the request further includes information describing a context of the application in which the advertisement content is to be presented.

9. The method of claim 8, wherein the information describing the context of the application in which the advertisement content is to be presented includes one or more selected from a group consisting of: a resolution with which content from the display is presented by the client device, an aspect ratio of the identified content capable of presenting the advertisement, a color of the identified content capable of presenting the advertisement, additional content presented by the application in conjunction with the identified content capable of presenting the advertisement, and any combination thereof.

10. The method of claim 8, wherein the request further includes one or more topics, at least one topic based at least in part on a context of the user while using the application.

11. The method of claim 1, wherein the application comprises a game executing on the client device.

12. The method of claim 10, wherein the identified content capable of presenting the advertisement to the user comprises an object presented to the user via the game.

13. The method of claim 12, wherein presenting the received advertisement to the user via the identified content capable of presenting the advertisement comprises:
presenting the received advertisement as an overlay on the object presented to the user via the game.

14. A computer program product comprising a computer readable storage medium having instructions encoded thereon that, when executed by a processor, cause the processor to:
execute an application on a client device, the application presenting content to a user of the client device;
identify content presented via the application capable of presenting an advertisement to the user;
transmit a request for advertisement content to an online system, the request including information identifying the user to the online system,
receive an advertisement selected for presentation to the user from the online system;
determine the identified content capable of presenting the advertisement to the user is presented to the user by the application;
present the received advertisement to the user via the identified content capable of presenting the advertisement;
in response to presenting the received advertisement, capture information describing a duration the received advertisement is presented to the user via the identified content capable of presenting the advertisement; and
transmit the captured information describing the duration to the online system.

15. The computer program product of claim 14, wherein determine the identified content capable of presenting the advertisement to the user is presented to the user by the application comprises:
determine the identified content is within a field of view of the user within the application.

16. The computer program product of claim 15, wherein determine the identified content is within the field of view of the user within the application comprises:
determine at least a threshold percentage of the identified content is within the field of view of the user within the application.

17. The computer program product of claim 15, wherein determine the identified content is within the field of view of the user within the application comprises:
determine at least a threshold amount of the identified content is presented to the user via the application.

18. The computer program product of claim 15, wherein capture information describing the duration the received advertisement is presented to the user via the identified content capable of presenting the advertisement comprises:
capture a length of time at least a threshold amount of the identified content is within the field of view of the user while the received advertisement is presented by the identified content.

19. The computer program product of claim 14, wherein the computer readable storage medium further has instructions encoded thereon that, when executed by the processor, cause the processor to:
cease presentation of the received advertisement in response to determining the identified content capable of presenting the advertisement to the user is no longer presented to the user by the application; and
transmit information describing the ceasing presentation of the received advertisement to the online system.

20. The computer program product of claim 14, wherein the request further includes information describing a context of the application in which the advertisement content is to be presented.
